(19) United States
(12) Patent Application Publication
(10) Pub. No.: US 2005/0119927 A1
(43) Pub. Date: Jun. 2, 2005

(54) Accounting for traveling time within scheduling software

(75) Inventor: Paritosh D. Patel, Parkland, FL (US)

Correspondence Address: AKERMAN SENTERFITT, P. O. BOX 3188, WEST PALM BEACH, FL, 33402-3188, US

(73) Assignee: International Business Machines Corporation, Armonk, NY (US)

(21) Appl. No.: 10/726,127

(22) Filed: Dec. 2, 2003

(51) Int. Cl. G06F 17/60

(52) U.S. Cl. 705/8

(57) ABSTRACT

A method for scheduling meetings within a scheduling application can include the step of identifying a meeting location and a meeting time for a meeting. An origination location can be determined for at least one meeting participant. Travel time for the participant can be automatically computed based at least in part upon the meeting location and the origination location. A time that is based at least in part upon the computed travel time can be presented within the scheduling application. For example, a suggested departure time can be computed and presented within the scheduling application, where the suggested departure time is based upon travel time and meeting time.

### BACKGROUND

1. Field of the Invention

The present invention relates to the field of computer software and, more particularly, to scheduling software that manages the travel time of meeting participants.

2. Description of the Related Art

Scheduling software is used to manage the myriad of details relating to meetings, including meeting locations, meeting times, and meeting participants. Typical scheduling software components can include calendars, contact address books, facility management features, task tracking capabilities, communication features, notification features, and the like. Effective use of scheduling software can result in lower meeting setup and coordination time and enhanced meeting attendance. When scheduling software is used to manage meetings, the number of meetings that are missed through lack of proper coordination and communication among meeting participants can be reduced.

Conventional scheduling software, however, has not averted meeting delays due to participants arriving late. One reason for these meeting delays is that meeting participants often fail to allocate sufficient travel time to arrive at scheduled meetings in a timely fashion. Insufficient travel time allocation can result from oversight, unrealistic optimism concerning necessary travel time, and unplanned travel difficulties. Travel difficulties can result from variable travel conditions, such as traffic, airline connections, and bus and train schedules, weather, accidents, and the like. At present, conventional scheduling software fails to provide meeting participants or meeting coordinators with travel time management and calculation tools that could allay meeting delays relating to meeting participant travel times.

### SUMMARY OF THE INVENTION

The present invention provides a method, a system, and an apparatus for accounting for travel time within scheduling software. More specifically, scheduling software can record and manage meeting related data including, but not limited to, meeting locations, meeting times, meeting participants, and the originating locations of the meeting participants. The scheduling software can automatically calculate travel times for meeting participants based upon originating locations and meeting destination locations. The travel times can be used to calculate suggested departure times, which can be presented to meeting participants. Further, the scheduling software can receive travel condition input, such as traffic and weather data, and can dynamically adjust travel time computations in an appropriate fashion to account for the received travel conditions. Additionally, the scheduling software can be used to dynamically adjust meeting specifics to account for travel related problems, such as missed airline flights.

One aspect of the present invention can include a method for scheduling meetings within a scheduling application. The method can include the step of identifying a meeting location and a meeting time. An origination location can be determined for at least one meeting participant. Travel time for the participant can be automatically computed based at least in part upon the meeting location and the origination location. A time based upon the computed travel time can be presented within the scheduling application. For example, a suggested departure time can be computed and presented within the scheduling application, where the suggested departure time is based upon travel time and meeting time. In one embodiment, at least one mode of communication can be offered for participating in the meeting in a timely fashion, where the offering step can be based at least in part upon the travel time and meeting time. Additionally, a meeting reminder can be automatically conveyed to the meeting participant at some time before the suggested departure time.

In a particular embodiment, an electronic message pertaining to a travel condition can be received and travel times for meeting participants can be responsively adjusted. In another embodiment, the scheduling application can utilize a calculated travel time to proactively determine that the participant will be unable to attend the meeting in a timely fashion. When this determination is made before the planned meeting time, some adjustment can be made so that the meeting participant can still attend the meeting on time. For example, the meeting time can be changed to a later time; the meeting location can be changed to reduce an associated travel time for the participant; and/or, a meeting participation methodology can be changed for the participant. That is, instead of attending a meeting physically, the meeting participant can attend in the meeting in a virtual manner. Virtual attendance can include teleconferencing, Web conferencing, video teleconferencing, and the like.

When a meeting adjustment is made, an electronic document can be responsively conveyed to each meeting participant. The electronic document can specify a meeting adjustment notification and/or a predicted absence notification. In one embodiment, a second meeting that is dependent upon the first meeting can be identified. When the first meeting exceeds a previously established meeting end time, one or more parameters of the second meeting can be automatically adjusted. Further, when the parameter of the second meeting is adjusted, an electronic document relating to the adjustment can be conveyed to each participant of the second meeting.

In another embodiment, a location matrix can be used to calculate the travel time for the scheduling application. The location matrix can include multiple location nodes joined by multiple link weights. Link weights can be values representing travel time that connect pairs of locations nodes. When calculating travel time, location nodes corresponding to the meeting location and to a participant's originating location can be identified. A travel pathway that includes at least one link weight can be plotted between the identified location nodes. Travel time can be computed based upon the link weight(s) of the travel pathway. Further, a link weight can be modified based upon a situation dependant circumstance, such as a travel condition. When the link weight is modified, the travel time can be calculated based upon the modified link weight and not upon a default link weight.

Another aspect of the present invention can include a system for managing meetings including a scheduling application, a travel time calculator, and/or a location matrix. The scheduling software can record a multitude of meeting events. Each of the meeting events can include a meeting location, a meeting start time, a multitude of meeting participants, and a multitude of origination locations. Each origination location can be associated with a meeting participant. In one embodiment, the scheduling application can determine a suggested meeting time for the meeting events based upon travel times of meeting participants associated with the meeting events.

The travel time calculator can calculate a travel time based at least in part upon a starting location and an ending location. The travel time can be calculated for one of the meeting participants using the associated originating location as the starting location and the meeting location as the ending location. In one embodiment, the travel calculator can receive travel condition input. In such an embodiment, a travel time calculation can be based at least in part upon the travel condition input.

The location matrix can be used by the travel time calculator to calculate travel times. The location matrix can include a multitude of location nodes, wherein connections between selected ones of the location nodes can be assigned link weights.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating an exemplary system for scheduling meetings in accordance with the inventive arrangements disclosed herein.

FIG. 2A is a schematic diagram illustrating an exemplary system for calculating travel time in accordance with the inventive arrangements disclosed herein.

FIG. 2B is a schematic diagram illustrating a reduction of the system of FIG. 2A when there is negligible travel time between selected locations in accordance with the inventive arrangements disclosed herein.

FIG. 3 is a flowchart illustrating a method for managing meetings in accordance with the inventive arrangements disclosed herein.

### DETAILED DESCRIPTION OF THE INVENTION

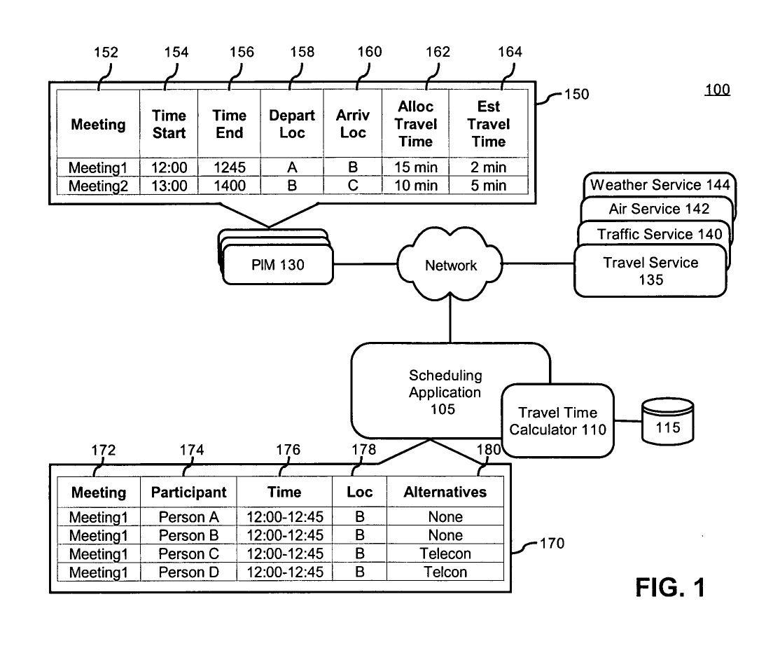

FIG. 1 is a schematic diagram illustrating an exemplary system 100 for scheduling meetings in accordance with the inventive arrangements disclosed herein. The system 100 can include a scheduling application 105 and a communicatively linked travel time calculator 110.

The scheduling application 105 can be any software application with meeting scheduling and coordination capabilities. The scheduling application 105 can be a network-based application that is communicatively linked to other scheduling applications, contact management systems, personal information management systems, and the like. The scheduling application 105 can also be a stand-alone software application that may or may not be capable of exchanging information with other software applications. Further, the scheduling application can be a client or a server based application. The scheduling application 105 can reside upon servers, desktop computers, mobile computer systems, personal data assistants, cellular telephones, and the like. Exemplary scheduling applications 105 can include Lotus Organizer (TM) by International Business Machines (IBM) of Armonk, N.Y., Lotus Notes (TM) by IBM, and the like.

The time travel calculator 110 can be a software application configured to calculate travel times based upon two locations, which represent a starting location and an ending location. The travel calculator 110 can be a stand-alone application communicatively linked to the scheduling application 105, can be a plug-in program adding capabilities to the scheduling application 105, and/or can be a functionality integrated within the scheduling application 105.

In one embodiment, the time travel calculator 110 can access a data store 115 to obtain travel and/or meeting information pertaining to meetings, locations, and travel conditions. The data store 115 can be any memory space configured to store and retrieve data. The time travel calculator 110 can also receive travel information from users and/or other applications, such as personal information manager (PIM) 130, scheduling application 105, travel service 135, traffic service 140, airline service 142, weather service 144, and the like. It should be noted that sources of travel information for system 100 are not limited to the explicitly listed information sources and that travel information can be provided by any of a variety of suitable sources. Additional travel information sources can include, for example, a bus service, a taxi service, a subway service, and a ferry service.

Travel information used by the time travel calculator 110 can be general as well as specific. General travel data can include, for example, distances between two locations, general travel times between locations, and the like. Specific travel information can include, but is not limited to, travel information specific to a mode of travel, location specific travel information, conditional traffic information for trips between specified locations, person-specific travel time information extrapolated from past trips, and the like.

Table 150 and table 170 are exemplary tables containing meeting and travel information that can be accessed by the scheduling application 105 and the travel time calculator 110. Table 150 is a table for storing meeting information for a particular person, such as a user of PIM 130. The table 150 can include a meeting column 152, a start time column 154, an end time column 156, a departure location column 158, an arrival location column 160, an allocated travel time column 162, an estimated travel time column 164, and the like.

The meeting column 152 can specify key values for uniquely identifying a meeting. The start time column 154 can record the scheduled start time for a meeting. The end time column 156 can record the scheduled end time for a meeting. The departure location column 158 can specify the location a person is departing from and the arrival location column 160 can specify the location to which the person is traveling. The allocated travel time column 162 can indicate the time that the person allowed themselves for travel to an associated meeting. The estimated travel time 164 can specify times calculated by the travel time calculator 110 that represent a system determined travel time. When the allocated travel time 162 is less than the estimated travel time 164, the scheduling application 105 can indicate that a potential scheduling problem exists.

Table 170 is a table for storing information specific a particular meeting. The table 170 can include a meeting column 172, a participant column 174, a time column 176, a location column 178, and an alternatives column 180, and the like. The meeting column 172 can specify key values for uniquely identifying a meeting. When records in table 170 and table 150 identify a meeting with the same key, the two records presumably represent the same meeting. The participant column 174 can specify participants that are to attend the associated meeting. The time column 176 can specify the duration of a meeting, including both start and end times. The location 178 can specify the location within which a meeting is to be conducted. The alternatives 180 can specify whether any alternatives to physical attendance are available for a meeting. Alternatives can refer to available virtual attendance options, such as telephony teleconferencing, video teleconferencing, Web conferencing, chatting, co-browsing, and the like. Alternatives can permit participants hampered by travel time to nevertheless participate in a meeting in a timely fashion.

In operation, a person can schedule a meeting using scheduling application 105 and enter a preferred meeting location and time. When meeting participants are designated, the scheduling application 105 can automatically determine participant locations from existing data sources. Additionally, the travel time calculator 110 can be used calculate the travel times of the meeting participants. The travel times combined with the preferred meeting time can be used to automatically calculate departure times for the participants.

In one embodiment, the scheduling application 105 can automatically facilitate travel arrangements for the participants by querying a multitude of travel related sources, including travel service 135 and airline service 142. The queries to travel sources can result in automatically generated travel itineraries. In another embodiment, the scheduling application 105 can suggest meeting times and/or locations to the person scheduling the meeting based upon the schedules of participants, available meeting locations, and the travel times/costs associated with the planned meeting.

It should be appreciated that table 150 and table 170 are intended for illustrative purposes only and that variances are permitted from the embodiments disclosed herein without departing from the spirit or essential attributes of the present invention.

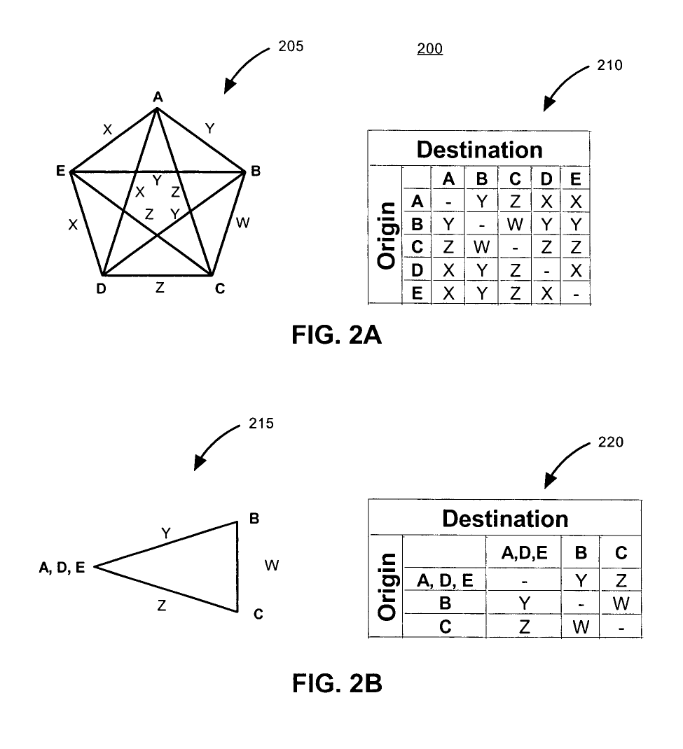

FIG. 2A is a schematic diagram illustrating an exemplary system 200 for calculating travel time in accordance with the inventive arrangements disclosed herein. It should be noted that the calculation methods disclosed in system 200 can be utilized by the travel time calculator 110 shown in FIG. 1. System 200 can include a location matrix 205 and a matrix table 210.

The location matrix 205 specifies nodes A, B, C, D, and E, each of which represents a location. The number of nodes in the location matrix 205 is not limited to five locations, and any number of locations can be expressed by the location matrix 205 so long as a corresponding node is added for each additional location. When travel is possible between locations, a line segment is drawn within the location matrix 205 between the appropriate location nodes. Similarly, when direct travel between two locations is not permitted, no line segment is drawn between the corresponding nodes.

For example, when travel restrictions exist between locations A and B making direct travel impossible, no line segment will connect nodes A and B. In such an example, an individual can follow a multi-node path, such as path A-C-B or A-D-B, to travel from location A to location B. Notably, geographical and security considerations can sometimes cause travel from a selected node to another to be impossible without traveling to one or more intervening nodes. As shown in system 200, no travel restrictions exist between nodes A, B, C, D, and E as a user can travel directly between each node.

Each line segment can have an associated numeric value called a link weight. The link weight can quantify the travel time needed to travel from one location to another. In one embodiment, multiple different link weights can be assigned to a single node pair, where each link weight can be associated with a particular mode of travel. Modes of travel can include, but are not limited to, walking, jogging, operating a wheelchair, driving a car, taking a cab, flying in an airplane, and the like.

The matrix table 210 can be an N by N matrix where N represents the number of nodes or locations that are represented within the matrix table 210. The matrix table 210 can be used to represent the location matrix 205. Accordingly, destination or ending locations can be represented by the columns of the matrix table 210, and the rows can represent starting or origination locations. The matrix table 210 can therefore include columns for nodes A, B, C, D, and E and rows for nodes A, B, C, D, and E. Cells within the matrix table 210 can represent link weights between nodes. For example, a link weight of Y is specified for travel from node A to node B. In another example, a link weight of Z is specified for travel from node C to node D.

In one embodiment, the matrix table 210 can represent directional pathways, where travel between locations can require different times depending on the direction of travel. For example, matrix table 210 can specify a time of ten minutes for traveling from an origin of A to a destination of B and a time of five minutes for traveling from an origin of B to a destination of A. In another embodiment, link weights between nodes can be the same in both directions, thereby representing non-directional pathways between nodes. One of ordinary skill in the art can appreciate that linear algebra transformations can be performed upon the matrix table 210 without a loss of stored information. Accordingly, when non-directional pathways are used, the matrix table 210 can be expressed as a simplified table.

FIG. 2B is a schematic diagram illustrating a reduction of the system of FIG. 2A in accordance with the inventive arrangements disclosed herein. More specifically, the location matrix 215 can be approximately equivalent to location matrix 205 when traveling the Distance X requires a negligible travel time. In location matrix 215, all the locations within X distance of one another can be collapsed into a single location. Accordingly, Location A, Location D, and Location E of location matrix 205 can be represented by Location A-D-E of location matrix 215.

The location matrix 215 can be represented by matrix table 220. The matrix table 220 can be a table where each destination location can be represented by a column and each originating location can be represented by a row. The matrix table 220 can therefore include columns for Location A-D-E, Location B, and Location C and rows for Location A-D-E, Location B, and Location C.

The creation of a reduced matrix, such as location matrix 220 that represents a reduction of location matrix 210, can dramatically reduce the overhead necessary for computing travel times without significantly decreasing the accuracy to these calculations. Such a reduction can be particularly important when travel times are computed for a large number of locations, as otherwise the number of necessary columns and rows of a matrix table can grow geometrically with the number of locations.

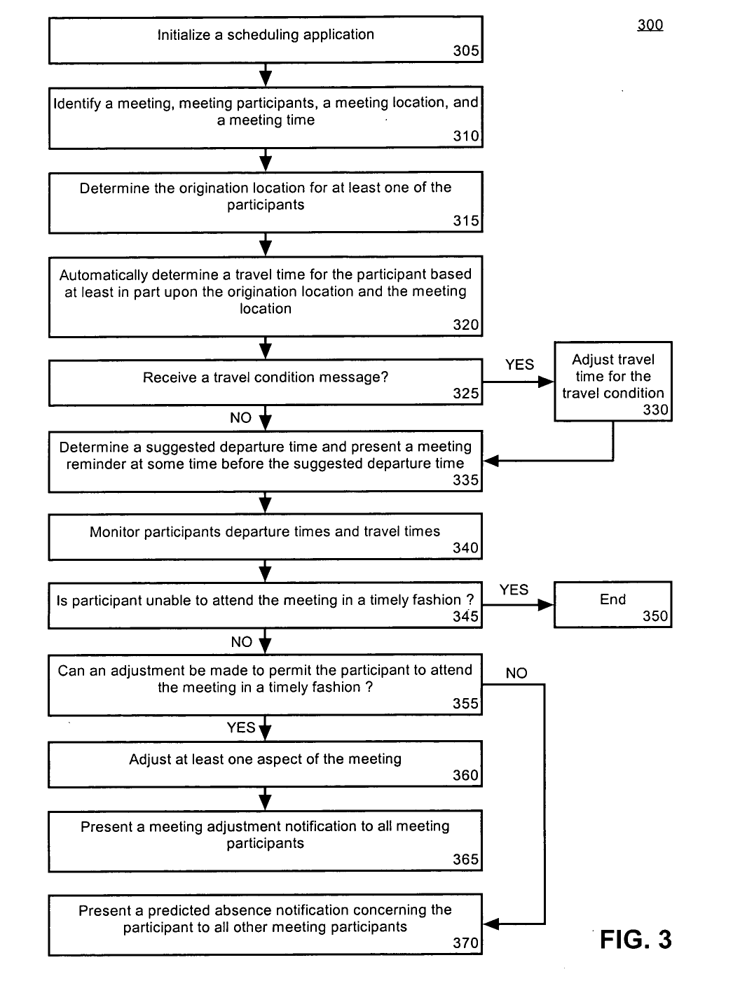

FIG. 3 is a flowchart illustrating a method 300 for managing meetings in accordance with the inventive arrangements disclosed herein. The method can be performed within the context of a scheduling application that includes travel time management capabilities. The method can begin in step 305, where a scheduling application can be initialized. In step 310, a meeting, meeting participants, a meeting location, and a meeting time can be determined within the scheduling application. In step 315, an origination location can be determined for at least one of the participants. In step 320, a travel time for the selected participant can be automatically determined based at least in part upon the origination location and the meeting location.

In step 325, the scheduling application can determine whether a travel condition has been received that relates to the participant. A travel condition can be any variable factor relating to traveling to a meeting that can affect the travel time. For example, if the participant's travel itinerary for the meeting includes an airplane flight, a travel condition can include a delay or cancellation of that flight. If the participant's travel itinerary includes an automobile trip, a travel condition can include a highway accident or other traffic condition within the anticipated travel route. If a travel condition is received, the method can proceed to step 330, where travel time can be appropriately adjusted. For example, when a travel condition indicates heavy highway traffic, then the travel time relating to an automobile trip can be increased by a suitable factor to allow for the heavy traffic. In another example, a meeting participant can input a physical condition affecting that participant's ability to travel, such as a disability or an injury. The scheduling application can responsively increase the travel times for the participant by a suitable factor. After appropriate adjustments are made, the method can continue to step 335. If no travel condition is determined in step 325, the method can proceed to step 335.

In step 335, a suggested departure time can be determined. In one embodiment, a meeting reminder can be presented at some time before the suggested departure time. For example, five minutes before a suggested departure time arrives, a meeting reminder popup window can be automatically presented to the meeting participant. In step 340, participant departure times and travel times can be monitored by the scheduling application. In step 345, a determination can be made as to whether the participant is able to attend the meeting in a timely fashion. If so, the method can proceed to step 350, where the activities of the scheduling application pertaining to the participant can end. The scheduling application can, however, continue to monitor other meetings and/or meeting participants.

If step 345 indicates that the participant cannot attend the meeting in a timely fashion, the method can proceed to step 355. In step 355, a determination can be made concerning whether a meeting adjustment is possible that would permit the participant to attend the meeting in a timely fashion. If an adjustment is possible, the method can proceed to step 360, where at least one aspect of the meeting can be adjusted. For example, the meeting time can be changed to a later time. In another example, the meeting location can be changed to reduce an associated travel time for the participant.

In still another example, a meeting adjustment can alter the method of participation from physical attendance (or other previously established participation methodology) to a different mode of communication. That is, instead of attending a meeting physically, the meeting participant can participate in the meeting in a virtual manner, including teleconferencing, Web conferencing, video teleconferencing, and the like. Because the alternate mode of communication can involve significantly less travel time than the originally planned attendance methodology, the participant can participate in the meeting in a timely fashion.

It should be noted that choosing which meeting adjustments are to be made for a particular meeting can involve a negotiation between the meeting coordinator and a participant experiencing time difficulties. For example, when a portion of meeting participants are already attending the meeting in a virtual manner, such as through video teleconferencing, it can be relatively simple for a participant who was planning to attend the meeting in a face-to-face manner to instead participate by video teleconferencing. It can be difficult, however, for a meeting coordinator to acquire the necessary equipment and/or set up the equipment in a timely fashion to permit meeting participants to participate through different communication modes than those originally planned. Therefore, it may be easier for the meeting coordinator to adjust the meeting time and/or location than to permit a participant to alter a communication mode. Meeting coordination software can be utilized to facilitate the negotiation of suitable meeting adjustments. In step 365, once a meeting adjustment has been made, a meeting adjustment notification can be sent to all meeting participants.

If step 355 indicates that no meeting adjustment solving the travel time problem can be made, then the method can proceed to step 370, where a predicted absence notification concerning the participant can be sent to all other meeting participants. Depending upon the relative importance of the participant, the meeting can then be canceled, a substitute meeting participant can be appointed, the meeting agenda can be adjusted, a notice advising other participants of a potential tardiness of the specified participant can be sent, and other appropriate actions can be taken.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

1. A method for scheduling meetings within a scheduling application comprising the steps of:
identifying a meeting location and a meeting time for a meeting;
determining an origination location for at least one meeting participant;
automatically computing a travel time for said participant based at least in part upon said meeting location and said origination location; and
presenting a time based at least in part upon said computed travel time when meeting information for said meeting is displayed within said scheduling application.

2. The method of claim 1, further comprising the step of:
offering at least one mode of communication for participating in said meeting in a timely fashion, wherein said offering step is based at least in part upon said travel time and meeting time.

3. The method of claim 1, wherein said presented time is a suggested departure time, said method further comprising the step of:
automatically conveying a meeting reminder to said participant at some time before said suggested departure time.

4. The method of claim 1, further comprising the steps of:
receiving an information message pertaining to a travel condition; and
dynamically adjusting said travel time based upon said travel condition.

5. The method of claim 1, further comprising the step of:
before said meeting time, determining based upon said travel time that said participant will be unable to arrive at said meeting on-time time without some adjustment being made.

6. The method of claim 5, further comprising the step of:
responsively adjusting at least one aspect of said meeting so that said meeting participant can attend said meeting in a timely fashion;

7. The method of claim 6, said adjusting step further comprising at least one of the following:
changing said meeting time to a later time;
changing said meeting location to reduce an associated travel time for said participant; and
changing a meeting participation methodology for said participant from physical meeting attendance to a virtual meeting attendance.

8. The method of claim 5, further comprising the step of:
responsively conveying an electronic document to each meeting participant, wherein said electronic document specifies at least one of a meeting adjustment notification and a predicted absence notification.

9. The method of claim 1, further comprising the steps of:
identifying a second meeting that is dependent upon said first meeting; and
automatically adjusting a parameter of said second meeting responsive to said first meeting exceeding a previously established meeting end time.

10. The method of claim 1, said computing step further comprising the step of:
constructing a location matrix comprising a plurality of location nodes;
connecting pairs of location nodes to each other; and
assigning a link weight to each of said connections between said location nodes, wherein said location matrix is used to calculate said travel time.

11. The method of claim 10, said computing step further comprising the steps of:
identifying a location node corresponding to said meeting location;
identifying a location node corresponding to said originating location;
plotting a travel pathway between said location nodes, said travel pathway comprising at least one link weight; and
calculating said travel time based at least in part upon said at least one link weight of said travel pathway.

12. The method of claim 10, said computing step further comprising the steps of:
modifying at least one link weight based on a situation dependant circumstance; and
calculating said travel time based at least in part upon said modified link weight.

13. A system for managing meetings comprising:
a scheduling application configured to manage a plurality of meeting events, each of said meeting events comprising a meeting location, and a plurality of meeting participants and originating locations, each meeting participant associated with a particular one of said originating locations; and
a travel time calculator configured to calculate a travel time between an original location and a meeting location based at least in part upon a starting location and an ending location, wherein said travel time is calculated for one of said meeting participants using said associated originating location as said starting location and said meeting location as said ending location.

14. The system of claim 13, further comprising:
a location matrix comprising a plurality of location nodes, wherein connections between selected ones of said location nodes are assigned link weights, wherein said travel time calculator uses said location matrix to calculate said travel time.

15. The system of claim 13, wherein said travel calculator is further configured to receive travel condition input, wherein said travel time calculation is based at least in part upon said travel condition input.

16. The system of claim 13, wherein said scheduling application is further configured to determine a suggested meeting time for said meeting events based upon travel times of meeting participants associated with said meeting events.

17. A machine-readable storage having stored thereon, a computer program having a plurality of code sections, said code sections executable by a machine for causing the machine to perform the steps of:
identifying a meeting location and a meeting time for a meeting;
determining an origination location for at least one meeting participant;
automatically computing a travel time for said participant based at least in part upon said meeting location and said origination location; and
presenting a time based at least in part upon said computed travel time when meeting information for said meeting is displayed within said scheduling application.

18. The machine-readable storage of claim 17, further comprising the step of:
offering at least one mode of communication for participating in said meeting in a timely fashion, wherein said offering step is based at least in part upon said travel time and meeting time.

19. The machine-readable storage of claim 17, wherein said presented time is a suggested departure time, said method further comprising the step of:
automatically conveying a meeting reminder to said participant at some time before said suggested departure time.

20. The machine-readable storage of claim 17, further comprising the steps of:
receiving an information message pertaining to a travel condition; and
dynamically adjusting said travel time based upon said travel condition.

21. The machine-readable storage of claim 17, further comprising the step of:
before said meeting time, determining based upon said travel time that said participant will be unable to arrive at said meeting on-time time without some adjustment being made.

22. The machine-readable storage of claim 21, further comprising the step of:
responsively adjusting at least one aspect of said meeting so that said meeting participant can attend said meeting in a timely fashion;

23. The machine-readable storage of claim 22, said adjusting step further comprising at least one of the following:
changing said meeting time to a later time;
changing said meeting location to reduce an associated travel time for said participant; and
changing a meeting participation methodology for said participant from physical meeting attendance to a virtual meeting attendance.

24. The machine-readable storage of claim 21, further comprising the step of:
responsively conveying an electronic document to each meeting participant, wherein said electronic document specifies at least one of a meeting adjustment notification and a predicted absence notification.

25. The machine-readable storage of claim 17, further comprising the steps of:
identifying a second meeting that is dependent upon said first meeting; and
automatically adjusting a parameter of said second meeting responsive to said first meeting exceeding a previously established meeting end time.

26. The machine-readable storage of claim 17, said computing step further comprising the step of:
constructing a location matrix comprising a plurality of location nodes;
connecting pairs of location nodes to each other; and
assigning a link weight to each of said connections between said location nodes, wherein said location matrix is used to calculate said travel time.

27. The machine-readable storage of claim 26, said computing step further comprising the steps of:
identifying a location node corresponding to said meeting location;
identifying a location node corresponding to said originating location;
plotting a travel pathway between said location nodes, said travel pathway comprising at least one link weight; and
calculating said travel time based at least in part upon said at least one link weight of said travel pathway.

28. The machine-readable storage of claim 26, said computing step further comprising the steps of:
modifying at least one link weight based on a situation dependant circumstance; and
calculating said travel time based at least in part upon said modified link weight.

29. A system for scheduling a meeting within a scheduling application comprising:
a meeting location;
a meeting time;
an origination location for at least one participant of said meeting;
means for automatically computing a travel time for said participant based at least in part upon said meeting location and said origination location; and
means for presenting a time based at least in part upon said travel time when meeting information for said meeting is displayed within said scheduling application.
